(19) United States
(12) Patent Application Publication
(10) Pub. No.: US 2018/0074770 A1
(43) Pub. Date: Mar. 15, 2018

(54) Driver Stress Management Device

(71) Applicants: Frances McGlinchey, Old Mystic, CT (US); Paul McGlinchey, Old Mystic, CT (US); Brian McGlinchey, Old Mystic, CT (US)

(72) Inventors: Frances McGlinchey, Old Mystic, CT (US); Paul McGlinchey, Old Mystic, CT (US); Brian McGlinchey, Old Mystic, CT (US)

(21) Appl. No.: 15/260,450

(22) Filed: Sep. 9, 2016

(51) Int. Cl. G06F 3/14; G06F 3/02; B60R 1/00

(52) U.S. Cl. CPC G06F 3/14; G06F 3/02; B60R 2300/302; G06F 2203/0384; B60R 1/00

(57) ABSTRACT

A driver stress management device for allowing a driver of a vehicle to express anger directed towards another driver in a manner which does not enhance actual danger to either driver includes a global positioning unit having a display screen. A fastener is coupled to the global positioning unit for placement in and fastening to a vehicle such that the display screen is visible to a driver of the vehicle. A trigger is placed in the vehicle where it is accessible to the driver of the vehicle. The trigger is operationally coupled to the global positioning unit whereby a visual image is displayed on the display screen when the trigger is actuated.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to stress management devices and more particularly pertains to a new stress management device for allowing a driver of a vehicle to express anger directed towards another driver in a manner which does not enhance actual danger to either driver.

### BRIEF SUMMARY OF THE INVENTION

An embodiment of the disclosure meets the needs presented above by generally comprising a global positioning unit having a display screen. A fastener is coupled to the global positioning unit for placement in and fastening to a vehicle such that the display screen is visible to a driver of the vehicle. A trigger is placed in the vehicle where it is accessible to the driver of the vehicle. The trigger is operationally coupled to the global positioning unit whereby a visual image is displayed on the display screen when the trigger is actuated.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front side perspective view of a driver stress management device according to an embodiment of the disclosure.

FIG. 2 is a partial rear view of an embodiment of the disclosure.

FIG. 3 is a front view of an embodiment of the disclosure in use.

FIG. 4 is a schematic view of an embodiment of the disclosure.

FIG. 5 is a top front side perspective view of an embodiment of the disclosure.

FIG. 6 is a schematic view of an embodiment of the disclosure.

### DETAILED DESCRIPTION OF THE INVENTION

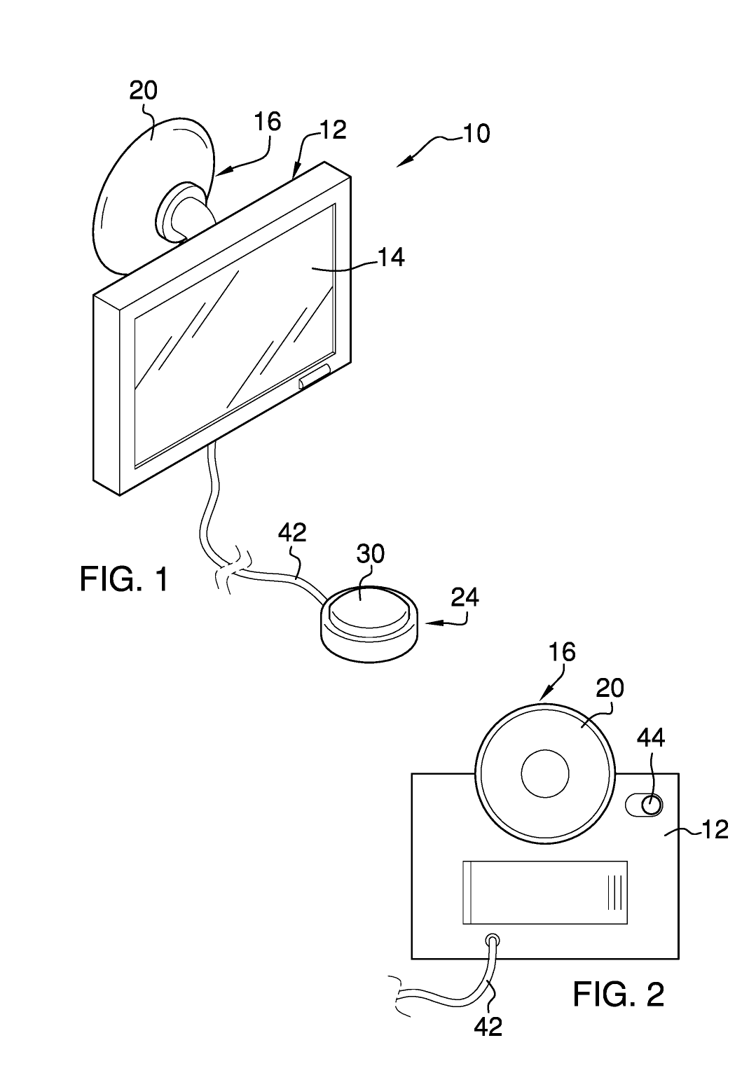

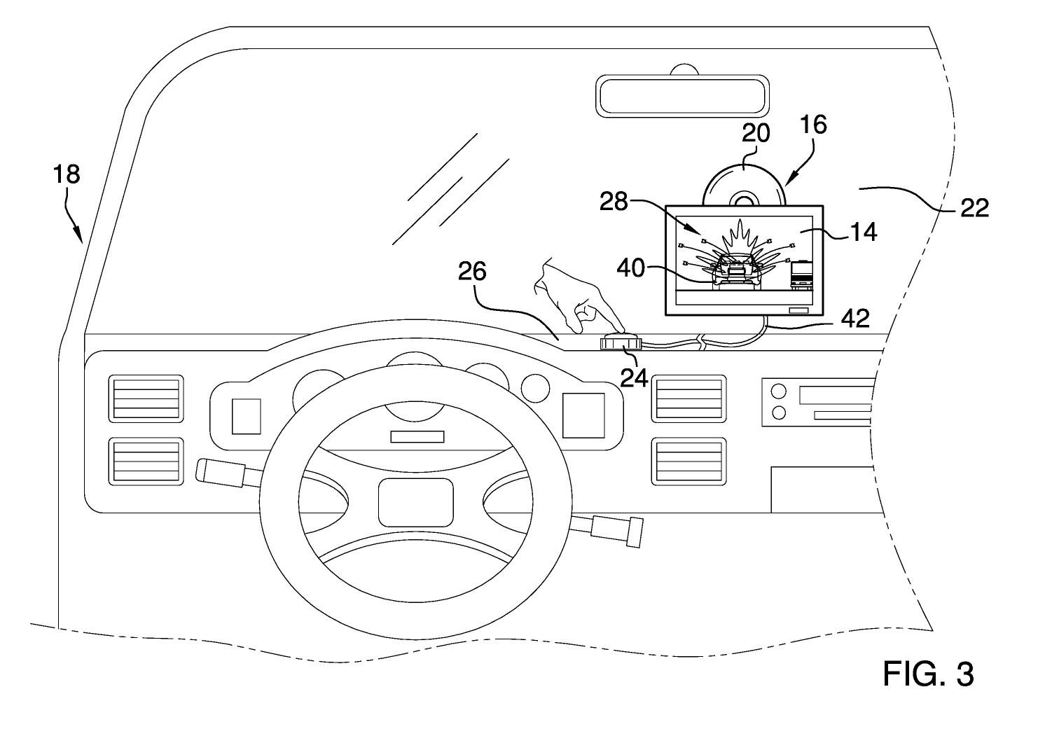

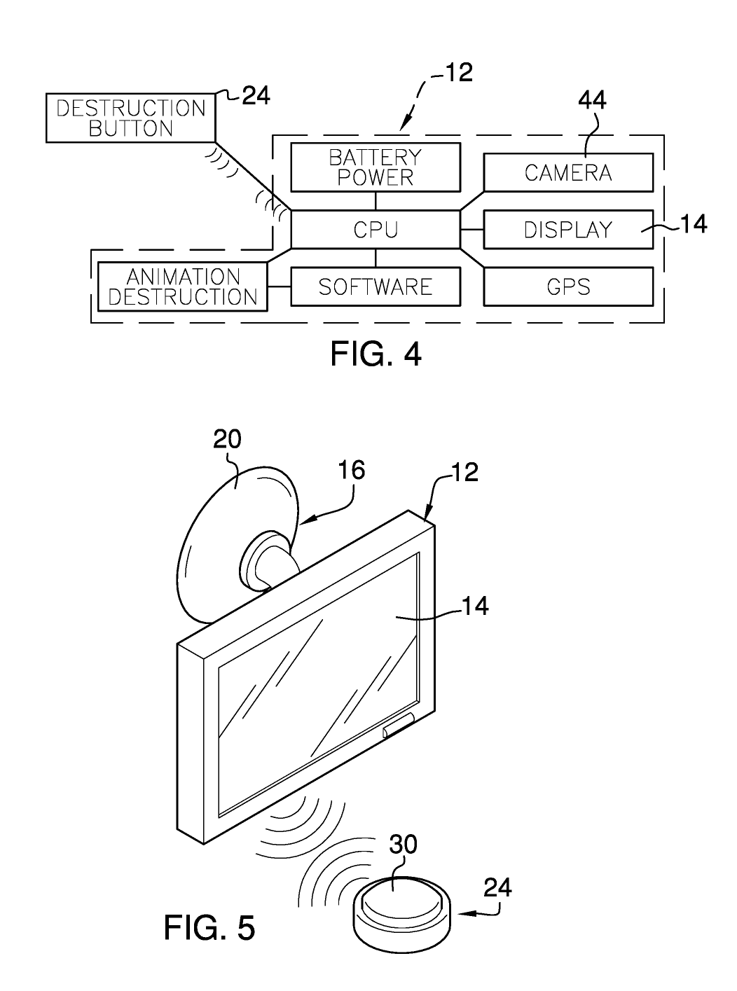

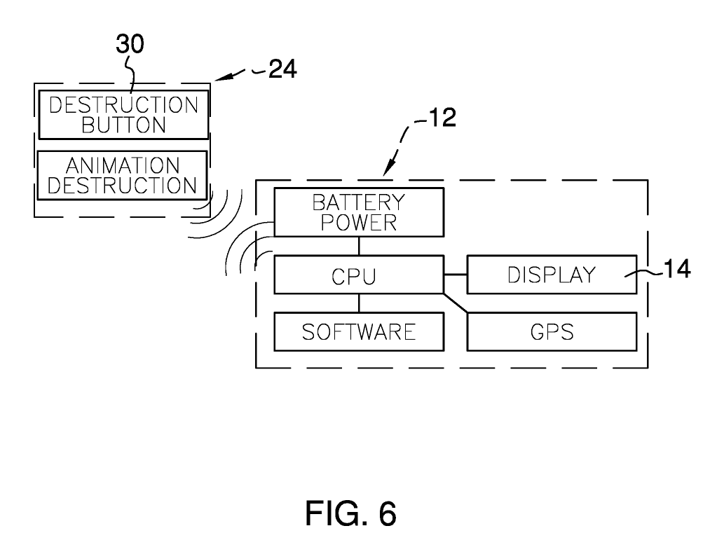

With reference now to the drawings, and in particular to FIGS. 1 through 6 thereof, a new stress management device embodying the principles and concepts of an embodiment of the disclosure and generally designated by the reference numeral 10 will be described.

As best illustrated in FIGS. 1 through 6, the driver stress management device 10 generally comprises a global positioning unit 12 having a display screen 14. A fastener 16 is coupled to the global positioning unit 12 wherein the global positioning unit 12 is configured for placement in and fastening to a vehicle 18 such that the display screen 14 is visible to a driver of the vehicle 18. The fastener 16 is a suction cup 20 allowing the global positioning unit 12 to be attached to a front windshield 22 of the vehicle 18. A trigger 24 is configured for placement in the vehicle 18 such that the trigger 24 is accessible to the driver of the vehicle 18. Placement may be on a dashboard 26 or any position sufficiently close to the driver position within the vehicle 18. The trigger 24 is operationally coupled to the global positioning unit 12 whereby a visual image 28 is displayed on the display screen 14 when the trigger 24 is actuated. The trigger 24 is a push button 30 or the like. The trigger 24 is extrinsic to the global positioning unit 12 meaning more specifically that the trigger 24 is not incorporated into a common housing with the global positioning unit 12. The visual image 28 is of an explosion wherein actuation of the trigger 24 is configured to give an appearance of an object in front of the vehicle 18 exploding in front of the driver of the vehicle 18. In an embodiment the trigger 24 is wirelessly coupled to the global positioning unit 12 by a personal access network. In this embodiment the global positioning unit 12 may be an existing device having personal access network capability allowing it to be retrofit by software updating for use with the trigger 24. In this embodiment the entirety of the visual image 28 may be transmitted from the trigger 24 including the explosion and a representative image of an outside vehicle 40 being in proximity to the explosion. In this embodiment, the visual image 28 is stored within the trigger 24 and transmitted to the global positioning unit 12 to be displayed on the display screen 14 when the trigger 24 is actuated. Thus, the driver of the vehicle 18 may express anger towards another and catharsis in the visual image as a safe representation of aggression being expressed towards another driver.

In a different embodiment, the device 10 includes the global positioning unit 12 as new equipment manufacture designed to work with the trigger 24. This embodiment have wireless communication between the trigger 24 and the global positioning unit 12, or a wire 42 may be used for coupling the trigger 24 to the global positioning unit 12. A camera 44 is coupled to the global positioning unit 12. The camera 44 faces an opposite direction relative to the display screen 14 wherein the camera 44 is configured for monitoring a forward direction while the display screen 14 is viewed by the driver of the vehicle 18. The visual image 28 displayed on the display screen 14 incorporates an image captured by the camera 44 combined with an explosion. The image captured by the camera 44 is captured when the trigger 24 is actuated. This gives the driver of the vehicle 18 a feeling and experience closer to that of aiming and firing an explosive weapon at a specific outside vehicle 40 to enhance the realism and cathartic effect.

In use, when driver aggression or another condition is experienced while driving, the driver of the vehicle 18 actuates the trigger 24 resulting in display of the visual image 28. The driver of the vehicle 18 then experiences a cathartic effect from retaliating and expressing their own increased anger or aggression in a safe manner. As the visual image 28 is expressed only within the vehicle 18, no actual aggression is communicated to the outside vehicle 40 and further escalation of aggression is prevented.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A driver stress management device comprising:
a global positioning unit having a display screen;
a fastener coupled to said global positioning unit wherein said global positioning unit being configured for placement in and fastening to a vehicle such that said display screen is visible to a driver of the vehicle; and
a trigger, said trigger being configured for placement in the vehicle such that said trigger is accessible to the driver of the vehicle, said trigger being operationally coupled to said global positioning unit whereby a visual image is displayed on said display screen when said trigger is actuated.

2. The device of claim 1, further comprising said fastener being a suction cup.

3. The device of claim 1, further comprising said trigger being a push button.

4. The device of claim 1, further comprising said trigger being extrinsic to said global positioning unit.

5. The device of claim 4, further comprising said trigger being wirelessly coupled to said global positioning unit by a personal access network.

6. The device of claim 5, further comprising said visual image being stored within said trigger and transmitted to said global positioning unit to be displayed on said display screen when said trigger is actuated.

7. The device of claim 4, further comprising a wire coupling said trigger to said global positioning unit.

8. The device of claim 1, further comprising a camera coupled to said global positioning unit, said camera facing an opposite direction relative to said display screen wherein said camera is configured for monitoring a forward direction while said display screen is viewed by the driver of the vehicle

9. The device of claim 8, further comprising said visual image displayed on said display screen incorporating an image captured by said camera.

10. The device of claim 9, further comprising said image captured by said camera being captured when said trigger is actuated.

11. A driver stress management device comprising:
a global positioning unit having a display screen;
a fastener coupled to said global positioning unit wherein said global positioning unit being configured for placement in and fastening to a vehicle such that said display screen is visible to a driver of the vehicle, said fastener being a suction cup; and
a trigger, said trigger being configured for placement in the vehicle such that said trigger is accessible to the driver of the vehicle, said trigger being operationally coupled to said global positioning unit whereby a visual image is displayed on said display screen when said trigger is actuated, said trigger being a push button, said trigger being extrinsic to said global positioning unit, said visual image being of an explosion wherein actuation of said trigger is configured to give an appearance of an object in front of the vehicle exploding in front of the driver of the vehicle.

12. The device of claim 11, further comprising:
said trigger being extrinsic to said global positioning unit, said trigger being wirelessly coupled to said global positioning unit by a personal access network; and
said visual image being stored within said trigger and transmitted to said global positioning unit to be displayed on said display screen when said trigger is actuated.

13. The device of claim 11, further comprising:
a wire coupling said trigger to said global positioning unit; and
a camera coupled to said global positioning unit, said camera facing an opposite direction relative to said display screen wherein said camera is configured for monitoring a forward direction while said display screen is viewed by the driver of the vehicle, said visual image displayed on said display screen incorporating an image captured by said camera, said image captured by said camera being captured when said trigger is actuated.
